(19) United States
(12) Patent Application Publication
(10) Pub. No.: US 2022/0276911 A1
(43) Pub. Date: Sep. 1, 2022

(54) USER CONTROLLED CUSTOMIZATION OF ACTIVITY FEED PRESENTATION

(71) Applicant: Citrix Systems, Inc., Fort Lauderdale, FL (US)

(72) Inventors: Abirami Sukumaran, Bangalore (IN); Christopher Alan Strauss, Boca Raton, FL (US)

(21) Appl. No.: 17/188,307

(22) Filed: Mar. 1, 2021

(51) Int. Cl. G06F 9/54; G06F 16/2457; H04L 29/06

(52) U.S. Cl. CPC G06F 9/542; G06F 16/24578; H04L 63/08

(57) ABSTRACT

One disclosed method involves receiving, by an application associated with a client device and from a computing system, at least a first notification of a first event of a first system of record accessed by the computing system using first access credentials associated with a user, the first notification being of a first notification type, and a second notification of a second event of a second system of record accessed by the computing system using second access credentials associated with the user, the second notification being of a second notification type, determining data corresponding to at least one input provided by the user to a user interface presented by the client device, the data indicating a preference for notifications of the first notification type as compared to notifications of the second notification type, and causing the client device to present the first notification earlier than the second notification in an activity feed generated by the application based at least in part on the preference indicated by the data.

### BACKGROUND

Various systems have been developed that allow client devices to access applications and/or data files over a network. Certain products offered by Citrix Systems, Inc., of Fort Lauderdale, Fla., including the Citrix Workspace™ family of products, provide such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method may involve receiving, by an application associated with a client device and from a computing system, at least a first notification of a first event of a first system of record accessed by the computing system using first access credentials associated with a user, the first notification being of a first notification type, and a second notification of a second event of a second system of record accessed by the computing system using second access credentials associated with the user, the second notification being of a second notification type. The method may further involve determining data corresponding to at least one input provided by the user to a user interface presented by the client device, the data indicating a first preference for notifications of the first notification type as compared to notifications of the second notification type, and causing the client device to present the first notification earlier than the second notification in an activity feed generated by the application based at least in part on the first preference indicated by the data.

In some disclosed embodiments, a first computing system may comprise at least one processor at least one computer-readable medium encoded with instructions which, when executed by the at least one processor, cause the first computing system to receive, by an application associated with a client device and from a second computing system, at least a first notification of a first event of a first system of record accessed by the second computing system using first access credentials associated with a user, the first notification being of a first notification type, and a second notification of a second event of a second system of record accessed by the second computing system using second access credentials associated with the user, the second notification being of a second notification type, to determine data corresponding to at least one input provided by the user to a user interface presented by the client device, the data indicating a first preference for notifications of the first notification type as compared to notifications of the second notification type, and to cause the client device to present the first notification earlier than the second notification in an activity feed generated by the application based at least in part on the first preference indicated by the data.

In some disclose embodiments, at least one non-transitory computer-readable medium may be encoded with instructions which, when executed by at least one processor of a first computing system, cause the first computing system to receive, by an application associated with a client device and from a second computing system, at least a first notification of a first event of a first system of record accessed by the second computing system using first access credentials associated with a user, the first notification being of a first notification type, and a second notification of a second event of a second system of record accessed by the second computing system using second access credentials associated with the user, the second notification being of a second notification type, to determine data corresponding to at least one input provided by the user to a user interface presented by the client device, the data indicating a first preference for notifications of the first notification type as compared to notifications of the second notification type, and to cause the client device to present the first notification earlier than the second notification in an activity feed generated by the application based at least in part on the first preference indicated by the data.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A shows an example display screen that includes user interface elements enabling a user of a client device to indicate notification type preferences for the user's activity feed;

FIG. 1B shows an example implementation of a user customizable activity feed generation system configured in accordance with some embodiments of the present disclosure;

FIG. 2 is a diagram of a network environment in which some embodiments of the user customizable activity feed generation system disclosed herein may deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a block diagram of an example system in which resource management services may manage and streamline access by clients to resource feeds (via one or more gateway services) and/or software-as-a-service (SaaS) applications;

FIG. 5B is a block diagram showing an example implementation of the system shown in FIG. 5A in which various resource management services as well as a gateway service are located within a cloud computing environment;

FIG. 5C is a block diagram similar to that shown in FIG. 5B but in which the available resources are represented by a single box labeled “systems of record,” and further in which several different services are included among the resource management services;

FIG. 5D shows how a display screen may appear when an intelligent activity feed feature of a multi-resource management system, such as that shown in FIG. 5C, is employed;

FIG. 6 is flow diagram showing a first example routine that may be performed by an application associated with the client device shown in FIG. 1B;

FIG. 7 is flow diagram showing a second example routine that may be performed by an application associated with the client device shown in FIG. 1B; and

FIG. 8 is flow diagram showing a third example routine that may be performed by an application associated with the client device shown in FIG. 1B.

### DETAILED DESCRIPTION

For purposes of reading the description of the various embodiments below, the following descriptions of the sections of the specification and their respective contents may be helpful:

Section A provides an introduction to example embodiments of a user customizable activity feed generation system;

Section B describes a network environment which may be useful for practicing embodiments described herein;

Section C describes a computing system which may be useful for practicing embodiments described herein;

Section D describes embodiments of systems and methods for accessing computing resources using a cloud computing environment;

Section E describes embodiments of systems and methods for managing and streamlining access by clients to a variety of resources;

Section F provides a more detailed description of example embodiments of the user customizable activity feed generation system that was introduced in Section A; and

Section G describes example implementations of methods, systems/devices, and computer-readable media in accordance with the present disclosure.

### A. Introduction to Illustrative Embodiments of a User Customizable Activity Feed Generation System

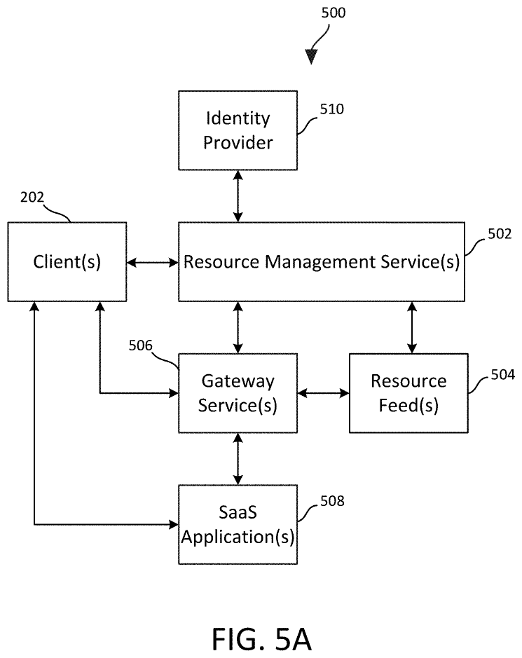

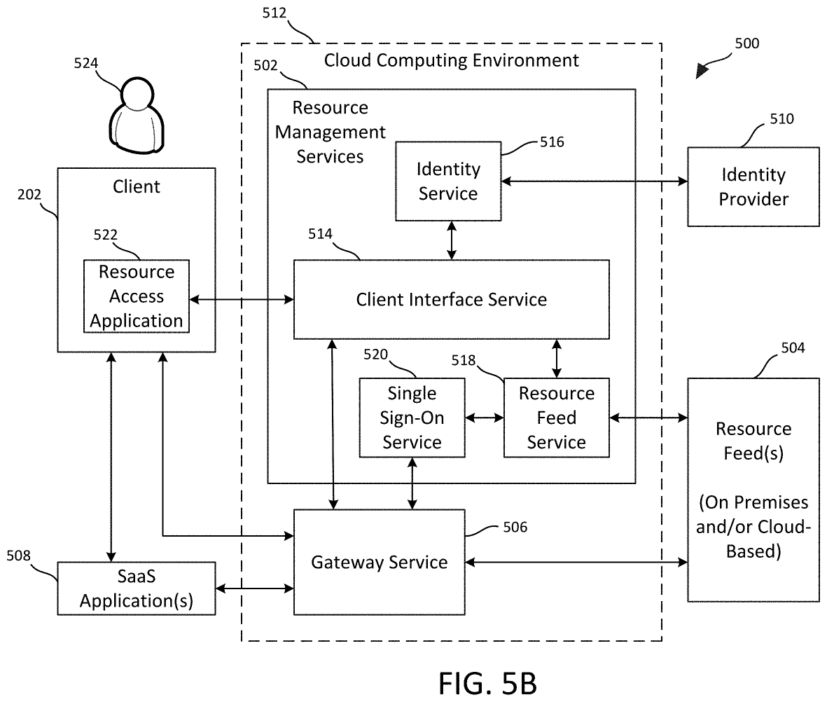

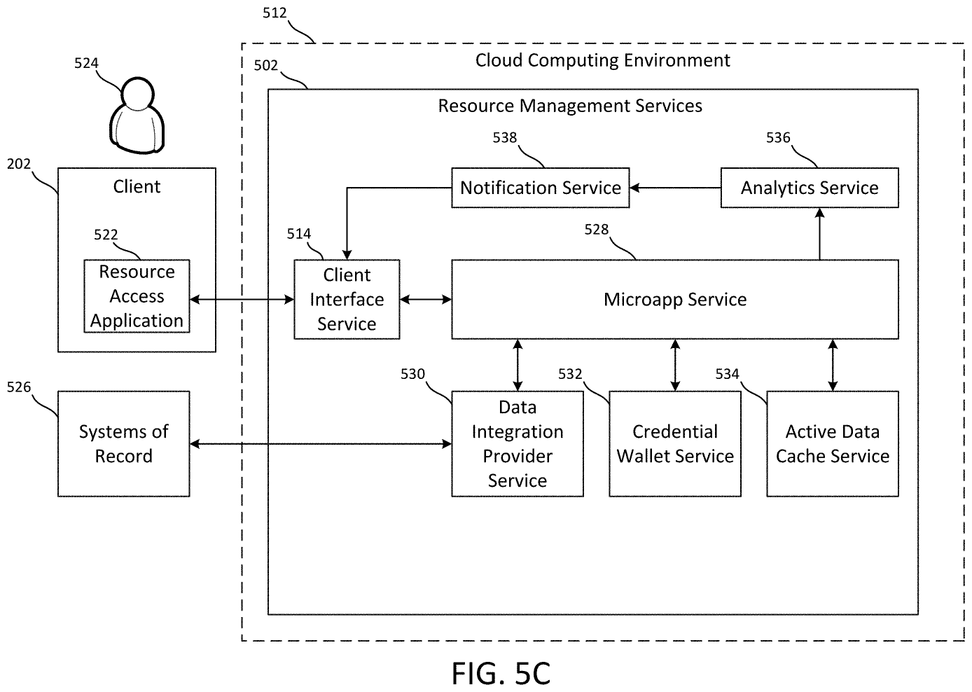

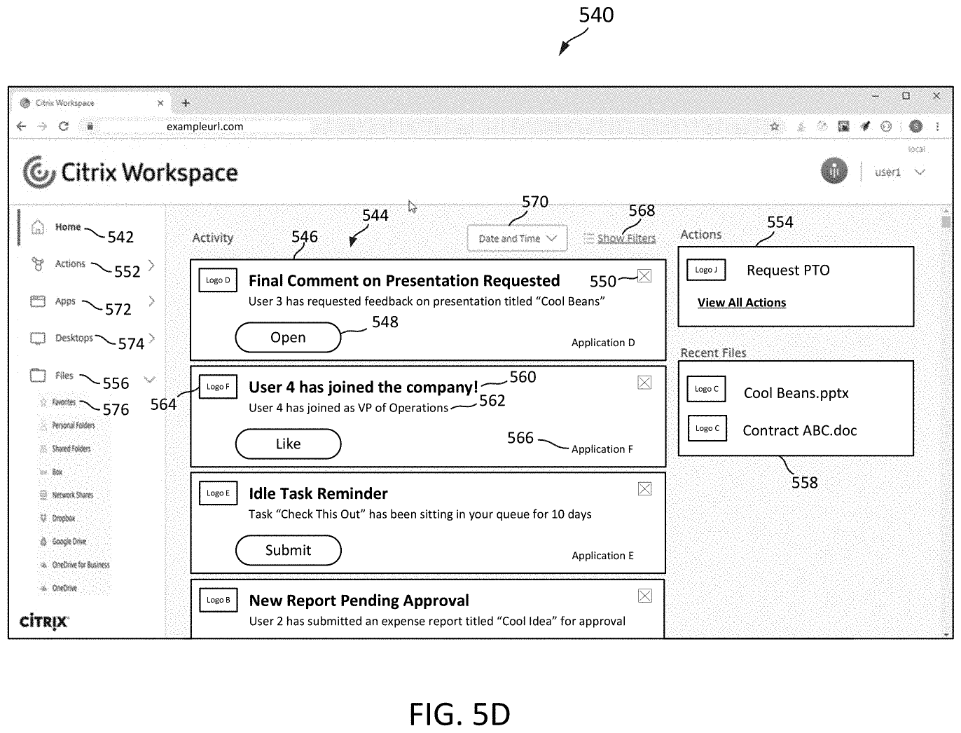

The multi-resource accesses system 500 described in Section E below (in connection with FIGS. 5A-D) provides many benefits, including providing a user 524 (shown in FIGS. 5B and 5C) with the ability to seamlessly access any of a number of resources from a user interface of a single application, e.g., the resource access application 522 shown in FIGS. 5B and 5C. The display screen 540 shown in FIG. 5D illustrates example features that may presented to the user 524 via such a user interface.

As Section E describes (in connection with FIG. 5D), the user interface presented by the resource access application 522 may, among other things, display an activity feed 544 that includes a plurality of notifications 546 about respective events that occurred within various applications to which the user has access rights. As Section E also describes, in some implementations, a user 524 may manipulate one or more user interface elements 570 to select a manner in which the notifications 546 are sorted within the activity feed. For example, the user interface element 570 may be controlled such that the notifications 546 are sorted in accordance with the “date and time” they were generated, in accordance with relevancy scores assigned to them by the analytics service 536, and/or based on the types of application to which they relate.

The inventors have recognized and appreciated that, while useful, such sorting methodologies may not be sufficient to keep the notifications 546 relevant and meaningful to at least some users and/or in at least some circumstances. In particular, the inventors have recognized and appreciated that different users may have different preferences and/or expectations with respect to how their activity feed 544 can or should be used to complete their day-to-day work tasks. For example, some work managers may find it desirable and efficient to review and complete personal time off (PTO) requests by interacting with notifications 546 in their activity feeds 546. But other work managers may instead prefer to respond to such PTO requests by directly accessing an application (e.g., Workaday), such as by selecting and launching such an application via the “Apps” user interface element 572 shown in FIG. 5D. While the “relevance scoring” models employed by the analytics service 536 could theoretically be trained to account for such preferences, provided a sufficient amount of historical data concerning a user's interaction with his or her activity feed 544 is accumulated and used to train such models, the user's experience in the meantime might be relatively poor. As such, those users might become frustrated and shy away from using the system, or even stop using it altogether, before the system can be trained adequately for such a purpose. Inundating the user with seemingly irrelevant notifications, even for just a short period of time, could greatly influence the user's desire or willingness to adopt the “activity feed” feature as a viable work tool going forward. Further, a user's preferences with respect to best uses for an activity feed 544 might change from time to time. For instance, a work manager might learn from a colleague that reviewing PTO requests via an activity feed 544 can increase the manager's productivity significantly and for that reason might want to begin reviewing PTO requests in such a manner. At present, such a user would have no way of directly instructing the system with respect to such a preference.

Offered is a technique that allows a user to readily control, or at least influence, the types of notifications that appear earliest in the user's activity feed 544. In particular, one or more user input mechanisms may be provided that allow the user to specify, via a client device 202, one or more preferences for certain notification types as compared to others. Further, as explained in more detail below, in some implementations, a compact and streamlined user interface control may be provided on a client device 202 that enables a user 524 to perform three distinct operations with respect to the activity feed 544 (i.e., filtering, sorting, and grouping of notifications 546), without the need to interact with and/or navigate to additional user interface controls.

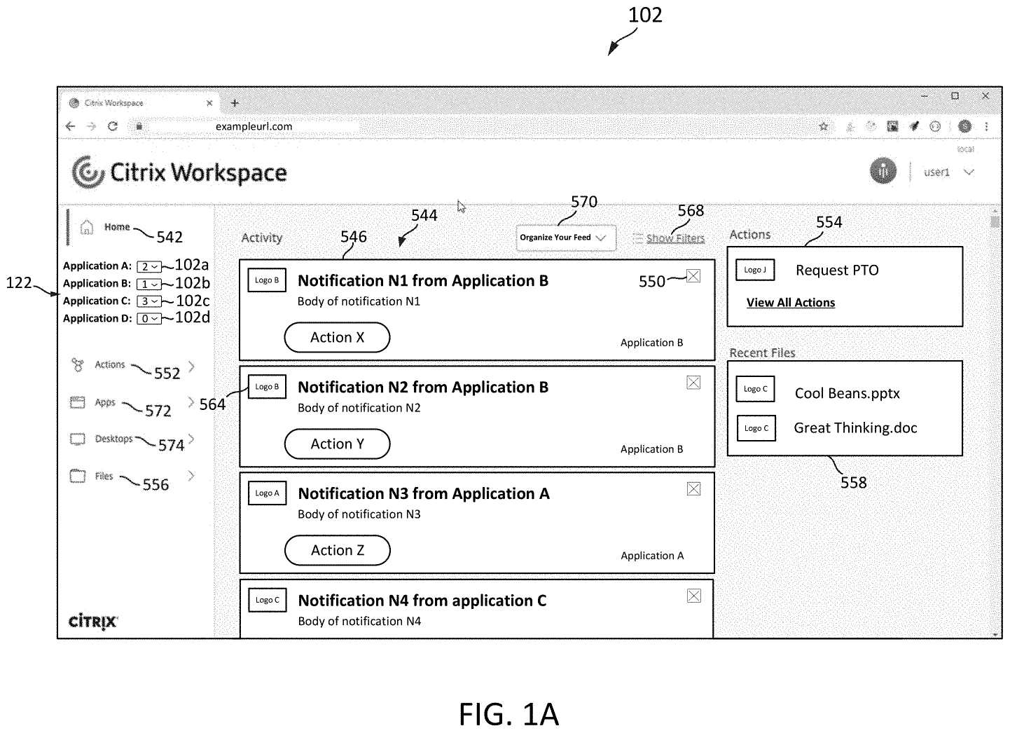

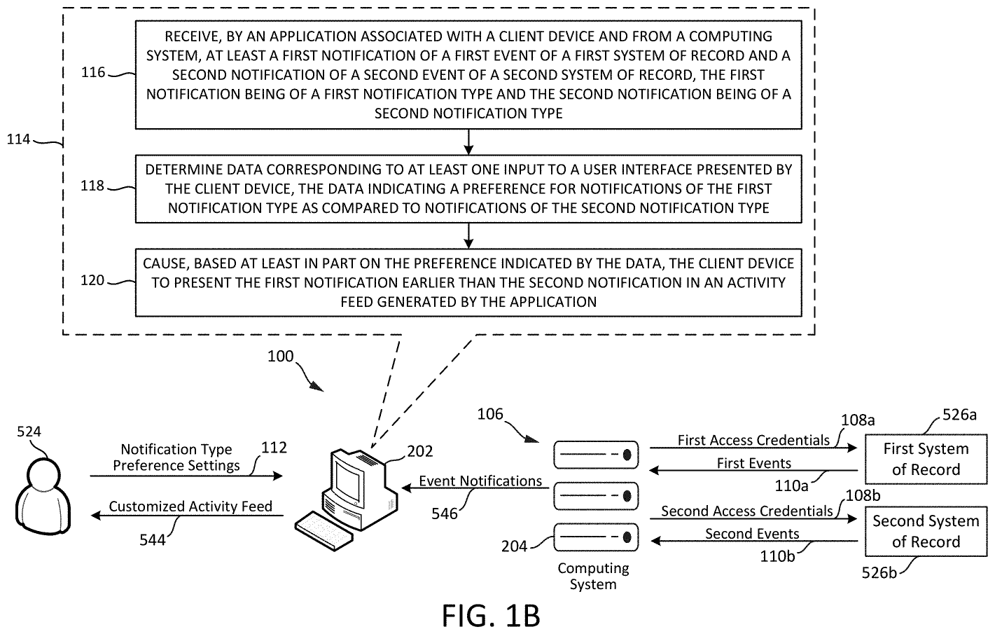

An example display screen 102 that may be presented by a client device 202 to allow a user 524 to specify such preferences is shown in FIG. 1A. The display screen 102 (shown in FIG. 1A) is similar to the screen 540 shown in FIG. 5D is many respects. As indicated, however, the display screen 102 (shown in FIG. 1A) may be configured to include a user interface control 122, e.g., including a group of user interface elements 104a-104d, that allows the user 524 to specify one or more preference rankings for respective types of notifications 546 that the resource management services 502 (shown in FIGS. 5B and 5C) are configured to provide to the client device 202. As illustrated in FIG. 1A, in some implementations, the user interface control, e.g., the group of user interface elements 104a-d, may be presented on the display screen 102 in response to the user 524 of the resource access application 522 (shown in FIG. 5C) operating the user interface element 570 to select an “organize your feed” option, or another option having a similar designation.

In the illustrated example, the individual user interface elements 104a-d are associated with respective applications for which the resource management services 502 is configured to provide event notifications 546. As indicated, the user 524 may manipulate the respective interface elements 104a-d to select preference rankings for the identified applications. In some implementations, a preference value of “0” may be selected to specify that the notifications 546 relating to particular applications are to be excluded from the activity feed 544. Further, in some implementations, a lower, non-zero number (e.g., “1”) may correspond to a more preferred rank than a higher, non-zero number (e.g., “3”). For instance, the selected states of the user interface elements 102a-d shown in FIG. 1A may indicate that notifications relating to the “Application D” are to be excluded from the activity feed 544 (because preference value of the user interface element 102d has been set to zero), and may further indicate that notifications 546 relating to “Application B” are to be presented earlier in the feed than notifications relating to “Application A” (because the preference value indicated by the user interface element 102b, i.e., “1” represents a more preferred rank than the preference value indicated by the user interface element 102a, i.e., “2”). As FIG. 1A illustrates, the individual notifications 546 in the activity feed may be sorted in accordance with the selected preference rankings.

In some implementations, the user interface elements 102a-d may be configured so that no two non-zero rankings for the indicated applications may be the same. For example, adjusting any of the non-zero numbers to a new value may cause other previously-selected values to be adjusted, as necessary, to account for the new selection and to ensure that all of the non-zero values remain different than one another. In such implementations, the activity feed 544 may present groups of notifications 546 from respective applications in an order dependent on the selected preference rankings, with a first group of notifications relating to the application having the most-preferred ranking appearing earliest in the feed, a second group of notifications relating to the next most preferred ranking appearing next in the feed, and so forth. In some implementations, the notifications 546 in such respective groups may further be sub-sorted based on some other criteria, e.g., the relevance scores assigned by the analytics service 536 or time stamps indicating when the notifications were generated. In some implementations, the criterion used for such sub-sorting within such notification groups may additionally be user-selectable, e.g., via an additional check-box, drop-down menu, or the like presented within the display screen 102 or otherwise.

In some implementations, the user interface elements 102a-d may instead be configured to allow two or more applications to be assigned the same non-zero ranking. In such implementations, the notifications 546 from the applications having the same ranking value may be sub-sorted based on some other criteria, e.g., the relevance scores assigned by the analytics service 536 or time stamps indicating when the notifications were generated. In some implementations, the criterion used for such sub-sorting amongst notifications 546 relating to applications having the same preference ranking may additionally be user-selectable, e.g., via an additional check-box, drop-down menu, or the like presented within the display screen 102 or otherwise. For instance, if a first application is assigned a ranking value of “1” and second and third applications are both assigned a ranking value of “2,” then the activity feed 544 may present notifications 546 from the first application earliest in the activity feed 544 (possibly sub-sorted based on a first indicated sub-sorting criterion), followed by a mixture of notifications from the second and third applications (possibly sub-sorted based on a second indicated sub-sorting criterion).

Although, in the illustrated example, the user interface elements 102a-d allow relevance rankings to be assigned to respective applications about which notifications 546 relate, it should be appreciated that, in other implementations, relevance rankings may be assigned to different notification types based on one or more other criteria, either in addition to or in lieu of the applications to which the notifications 546 relate. In some implementations, for example, multiple different types of notifications 546 relating to the same application may be indicated, and separate preference rankings may be assigned for such different notification types. For instance, for a Workaday application, the user 524 may be permitted to set a first preference ranking for notifications 546 concerning PTO request and a second, different preference ranking for notifications 546 concerning expense report approval requests. In some implementations, one or more of the user interface elements 102a-d shown in FIG. 1A may, for example, have an expansion element (not illustrated) that allows a user to view sub-categories of notification types for the indicated application and to select individual preference rankings for the respective sub-categories that are revealed when such an expansion element is selected.

As can be appreciated from the foregoing description, the user interface control 122 may thus provide a compact and streamlined mechanism that enables a user 524 to perform three distinct operations with respect to the activity feed 544 (i.e., filtering, sorting, and grouping of notifications 546), without the need to interact with and/or navigate to additional user interface controls. In particular, a user 524 may operate the user interface control 122 to (A) control the filtering of notifications 546 from the activity feed 544, e.g., by setting a preference value of one or more user interface elements 102 to “0,” (B) control the sorting notifications 546 in the activity feed 544, e.g., by adjusting non-zero preference values of one or more of the user interface elements 102, and (C) control the grouping of notifications 546 in the activity feed 544, e.g., by operating one or more of the user interface elements 102 to select different non-zero preference values for respective notification types.

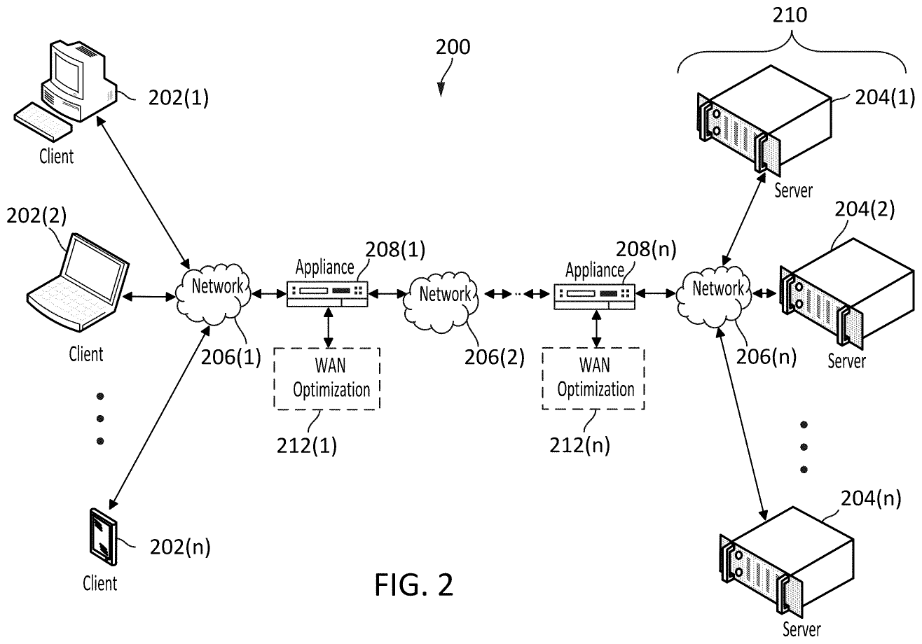

FIG. 1B shows an example implementation of a computing environment 100 with which some aspects of the present disclosure may be implemented. As shown, the computing environment may include a client device 202, a computing system 106 (which may, for example, be implemented by one or more severs 204), and a plurality of systems of record 526 with which the computing system 106 may interact on behalf of a user 524 of the client device 202. Examples of components that may be used to implement the client device 202 and the servers 204, as well as examples of computing environments in which such components may be deployed, are described below in connection with FIGS. 2-4. In some implementations, the computing system 106 may correspond to one or more components of the resource management services 502 described below in connection with FIGS. 5A-C. As described in connection with FIG. 5C, for example, in some implementations, the data integration provider service 530 may use access credentials associated with a user 524 (e.g., retrieved from the credential wallet service 532) to access various systems of record 526 (e.g., via application programming interface (API) calls to the systems of record 526) on behalf of the user 524, and retrieve data from those systems of record 526 that is indicative of events that may be pertinent to the user 524. Similarly, as shown in FIG. 1B, the computing system 106 may use first access credentials 108a to access data relating to first events 110a from a first system of record 526a, and may use second access credentials 108b to access data relating to second events 110b from a second system of record 526b. As also shown in FIG. 1, the computing system 106 may further generate event notifications 546 indicative of the events 110a, 110b, and may send those notifications 546 to the client device 202 the user 524 is operating.

As further illustrated in FIG. 1B, in accordance with some aspects of the present disclosure, the user 524 may input one or more notification type preference settings 112 via a user interface presented by the client device 202, and the client device 202 may be caused to output a customized activity feed 544 in which the notifications 546 are sorted, filtered and/or grouped based at least in part on the input notification type preference settings 112. The notification type preference settings 112 may, for example, correspond to the preference rankings indicated by the user input elements 104a-d shown in FIG. 1A. The customized activity feed 544 shown in FIG. 1B may, for example, correspond to the activity feed 544 shown in FIG. 1A. As described above, the notifications 546 in the customized activity feed 544 shown in FIG. 1A may be sort, filtered, and/or grouped based on the ranking values input via the user interface elements 104a-d. In some implementations, the notification type preference settings 112 input by a user may be sent to the computing system 106 for storage, e.g., along with other profile data of the user 524, so that such settings may subsequently retrieved and used by the same or a different client device 202 when the user 524 next accesses the computing system 106 (e.g., via a resource assess application 522). In some implementations, for example, the notification service 538 shown in FIG. 5C (or another component of the resource management services 502) may be configured with an API that can be used to store and retrieve data indicative of the notification type preference settings 112 that are input by a user 524.

The notification type preference settings 112 may be used to influence the content and/or presentation of the customized activity feed 544 in any of a number of ways. In some implementations, for example, the notification type preference settings 112 may be used by an application associated with the client device 202 (e.g., the resource access application 522 shown in FIG. 5C) to determine how to sort, filter, and/or group any notifications 546 that have been received from the computing system 106. In some implementations, for example, metadata associated with the received notifications 546 may indicate the respective applications to which such notifications 546 relate and/or may indicate particular types of events that were detected within such applications. As such, in such implementations, the application associated with the client device 202 (e.g., the resource access application 522 shown in FIG. 5C) may use that metadata, together with the notification type preference settings 112, to determine how to present the customized activity feed 544 to the user 524.

In other implementations, an application associated with the client device 202 (e.g., the resource access application 522 shown in FIG. 5C) may additionally or alternatively use some or all of the notification type preference settings 112 to determine weighting values that are to be applied to relevance scores that were assigned to respective notifications 546 by the computing system 106 (e.g., by the analytics service 536 described below in connection with FIG. 5C) to determine weighted relevance scores for the received notifications 546. The application associated with the client device 202 (e.g., the resource access application 522 shown in FIG. 5C) may then use such weighted relevance scores to determine how to sort, filter, and/or group the received notifications 546.

In still other implementations, some or all of the notification type preference settings 112 may additionally or alternatively be sent to the computing system 106, and one or more components of the computing system 106 (e.g., the analytics service 536 described in connection with FIG. 5C) may take such preference settings 112 into account when generating relevance scores for the notifications 546 that are to be sent to the application associated with the client device 202 (e.g., the resource access application 522 shown in FIG. 5C).

FIG. 1B shows an example routine 114 that may be executed by an application associated with the client device 202 in accordance with some embodiments. As shown, at a step 116 of the routine 114, the application may receive, from the computing system 106, at least a first notification 546 of a first event 110a of the first system of record 526a, and a second notification 546 of a second event 110b of the second system of record 526b. As the text of the step 116 indicates, the first notification 546 may be of a first notification type and the second notification 546 may be of a second notification type that is different than the first notification type. In some implementations, the application associated with the client device 202 may, for example, be the resource access application 522 (shown in FIGS. 5B and 5C). As described in connection with FIG. 5B, the resource access application 522 may either be installed on the client 202, or may be executed by the client interface service 514 (or elsewhere in the multi-resource access system 500) and accessed using a web browser (not shown in FIG. 5B) on the client 202.

As discussed above, in some implementations, the computing system 106 may have used the first access credentials 108a to access the first system of record 526a to obtain data relating to the first event 110a to which the first notification 546 relates, and may have used the second access credentials 108b to access the second system of record 526b to obtain data relating to the second event 110b to which the second notification 546 relates.

At a step 118 of the routine 114, the client device 202 may determine data (e.g., the notification type preference settings 112) corresponding to at least one input provided by the user 524 to a user interface presented by the client device 202 (e.g., via one or more of the user interface elements 104a-d shown in FIG. 1A), the data indicating a preference for notifications 546 of the first notification type as compared to notifications 546 of the second notification type. As noted above, such a preference may be indicated, for example, by the user operating the user interface elements 104a-d to select preference ranking values for respective systems of record 526 and/or for respective types of notifications that such systems of record 526 are configured to generate.

At a step 120 of the routine 114, the client device 202 may be caused, based at least in part on the preference indicated by the data (e.g., the notification type preference settings 112), to present the first notification 546 earlier than the second notification 546 in an activity feed 544 generated by the application (e.g., the resource access application 522). As noted above, the client device 202 may use the notification type preference settings 112 to influence the content and/or presentation of the customized activity feed 544 in any of a number of ways, including using some or all of such settings, either alone or in combination with relevance scores assigned to notifications, to determine how to sort, filter, and/or group any notifications 546 that have been received from the computing system 106, and/or by sending data indicative of some or all of such settings to the computing system 106, so as to cause one or more components of the computing system 106 (e.g., the analytics service 536 described in connection with FIG. 5C) to take such preference settings 112 into account when generating relevance scores for the notifications 546 that are to be sent to the client device 202.

Additional details and example implementations of embodiments of the present disclosure are set forth below in Section F, following a description of example systems and network environments in which such embodiments may be deployed.

### B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

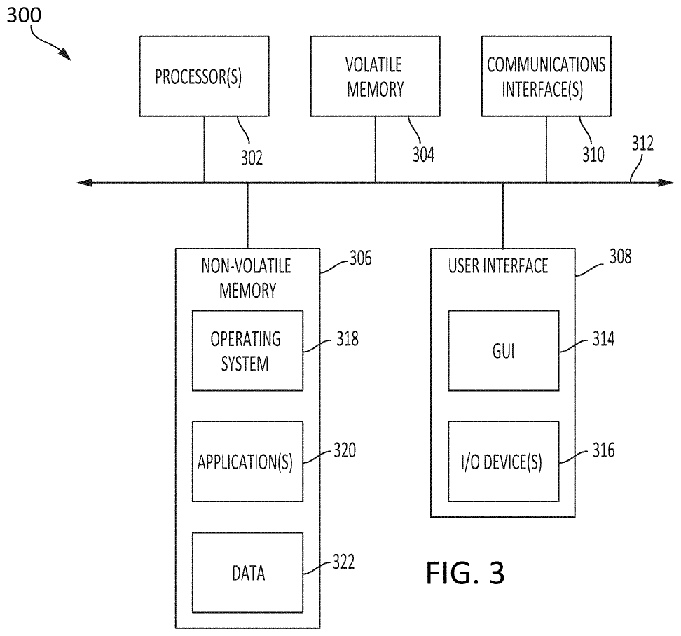

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

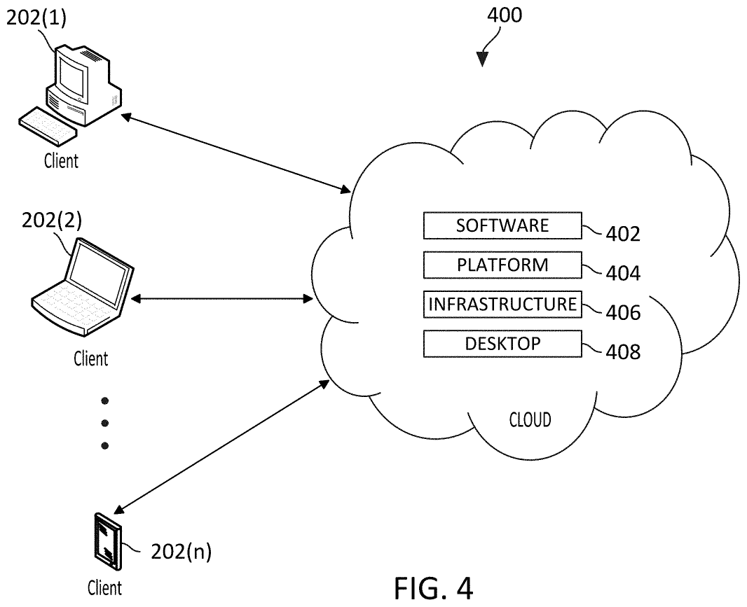

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Systems and Methods for Managing and Streamlining Access by Client Devices to a Variety of Resources

FIG. 5A is a block diagram of an example multi-resource access system 500 in which one or more resource management services 502 may manage and streamline access by one or more clients 202 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 202 and, following authentication, identify one or more resources the user is authorized to access. In response to the user selecting one of the identified resources, the resource management service(s) 502 may send appropriate access credentials to the requesting client 202, and the client 202 may then use those credentials to access the selected resource. For the resource feed(s) 504, the client 202 may use the supplied credentials to access the selected resource via a gateway service 506. For the SaaS application(s) 508, the client 202 may use the credentials to access the selected application directly.

The client(s) 202 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 202, one or more file repositories and/or file sharing systems, one or more secure browser services, one or more access control services for the SaaS applications 508, one or more management services for local applications on the client(s) 202, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 202) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 202 may use a resource access application 522 to communicate with the client interface service 514 as well as to present a user interface on the client 202 that a user 524 can operate to access the resource feed(s) 504 and/or the SaaS application(s) 508. The resource access application 522 may either be installed on the client 202, or may be executed by the client interface service 514 (or elsewhere in the multi-resource access system 500) and accessed using a web browser (not shown in FIG. 5B) on the client 202.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., user-name and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 202 to be redirected to the cloud-based identity service to complete an authentication process. The cloud-based identity service may then cause the client 202 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 202 may proceed to access the selected resource.

When the user 524 selects a local application, the resource access application 522 may cause the selected local application to launch on the client 202. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 202 may then launch the identified browser and initiate a connection to the gateway service 506. The gateway service 506 may then request an assertion from the single sign-on service 520. Upon receiving the assertion, the gateway service 506 may cause the identified browser on the client 202 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 202 to access the selected SaaS application 508.

In some embodiments, the preferred browser identified by the gateway service 506 may be a specialized browser embedded in the resource access application 522 (when the resource application is installed on the client 202) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 202, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 202. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and 6ML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically pull active data from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 202 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 202 as a push notification to the user 524.

In some embodiments, a process for processing a user-initiated action via a microapp may operate as follows. The client 202 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted Oauth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

FIG. 5D shows how a display screen 540 presented by a resource access application 522 (shown in FIG. 5C) may appear when an intelligent activity feed feature is employed and a user is logged on to the system. Such a screen may be provided, for example, when the user clicks on or otherwise selects a “home” user interface element 542. As shown, an activity feed 544 may be presented on the screen 540 that includes a plurality of notifications 546 about respective events that occurred within various applications to which the user has access rights. An example implementation of a system capable of providing an activity feed 544 like that shown is described above in connection with FIG. 5C. As explained above, a user's authentication credentials may be used to gain access to various systems of record (e.g., SalesForce, Ariba, Concur, RightSignature, etc.) with which the user has accounts, and events that occur within such systems of record may be evaluated to generate notifications 546 to the user concerning actions that the user can take relating to such events. As shown in FIG. 5D, in some implementations, the notifications 546 may include a title 560 and a body 562, and may also include a logo 564 and/or a name 566 of the system of record to which the notification 546 corresponds, thus helping the user understand the proper context with which to decide how best to respond to the notification 546. In some implementations, one or more filters may be used to control the types, date ranges, etc., of the notifications 546 that are presented in the activity feed 544. The filters that can be used for this purpose may be revealed, for example, by clicking on or otherwise selecting the “show filters” user interface element 568. Further, in some embodiments, a user interface element 570 may additionally or alternatively be employed to select a manner in which the notifications 546 are sorted within the activity feed. In some implementations, for example, the notifications 546 may be sorted in accordance with the “date and time” they were created (as shown for the element 570 in FIG. 5D), a “relevancy” mode (not illustrated) may be selected (e.g., using the element 570) in which the notifications may be sorted based on relevancy scores assigned to them by the analytics service 536, and/or an “application” mode (not illustrated) may be selected (e.g., using the element 570) in which the notifications 546 may be sorted by application type.

When presented with such an activity feed 544, the user may respond to the notifications 546 by clicking on or otherwise selecting a corresponding action element 548 (e.g., “Approve,” “Reject,” “Open,” “Like,” “Submit,” etc.), or else by dismissing the notification, e.g., by clicking on or otherwise selecting a “close” element 550. As explained in connection with FIG. 5C below, the notifications 546 and corresponding action elements 548 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 546 (e.g., in a separate, pop-up window corresponding to the microapp) by clicking on or otherwise selecting a portion of the notification 546 other than one of the user interface elements 548, 550. In some embodiments, the user may additionally or alternatively be able to select a user interface element either within the notification 546 or within a separate window corresponding to the microapp that allows the user to launch the native application to which the notification relates and respond to the event that prompted the notification via that native application rather than via the microapp. In addition to the event-driven actions accessible via the action elements 548 in the notifications 546, a user may alternatively initiate microapp actions by selecting a desired action, e.g., via a drop-down menu accessible using the “action” user interface element 552 or by selecting a desired action from a list 554 of recently and/or commonly used microapp actions. As shown, additional resources may also be accessed through the screen 540 by clicking on or otherwise selecting one or more other user interface elements that may be presented on the screen. For example, in some embodiments, the user may also access files (e.g., via a Citrix ShareFile™ platform) by selecting a desired file, e.g., via a drop-down menu accessible using the “files” user interface element 556 or by selecting a desired file from a list 558 of recently and/or commonly used files. Further, in some embodiments, one or more applications may additionally or alternatively be accessible (e.g., via a Citrix Virtual Apps and Desktops™ service) by clicking on or otherwise selecting an “apps” user interface element 572 to reveal a list of accessible applications or by selecting a desired application from a list (not shown in FIG. 5D but similar to the list 558) of recently and/or commonly used applications. And still further, in some implementations, one or more desktops may additionally or alternatively be accessed (e.g., via a Citrix Virtual Apps and Desktops™ service) by clicking on or otherwise selecting a “desktops” user interface element 574 to reveal a list of accessible desktops or by or by selecting a desired desktop from a list (not shown in FIG. 5D but similar to the list 558) of recently and/or commonly used desktops.

The activity feed shown in FIG. 5D provides significant benefits, as it allows a user to respond to application-specific events generated by disparate systems of record without needing to navigate to, launch, and interface with multiple different native applications.

### F. Detailed Description of Example Embodiments of the User Customizable Activity Feed Generation System Introduced in Section a

As described above in Section A (with reference to FIGS. 1A and 1B), in accordance with some embodiments of the present disclosure, a user interface control 122, e.g., including a group of user interface elements 104a-104d, may be presented by a client device 202 that allows the user 524 to specify one or more preference settings 112 for respective types of notifications 546 that the resource management services 502 (shown in FIGS. 5B and 5C) are configured to provide to the client device 202. Further, as also described in Section A, in some implementations, the client device 202 may be caused to output a customized activity feed 544 in which the notifications 546 are sorted, filtered and/or grouped based at least in part on the input notification type preference settings 112.

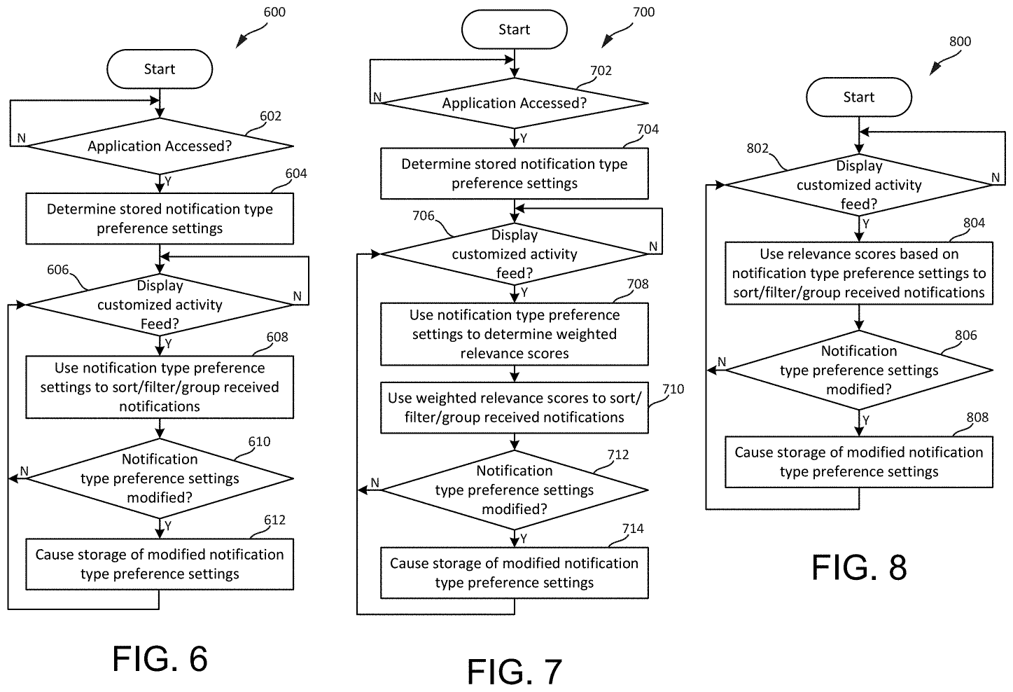

FIGS. 6-8 show three example routines 600, 700, 800 that may be executed by an application associated with the client device 202 shown in FIG. 1B (e.g., by the resource access application 522 shown in FIGS. 5B and 5C) to implement the foregoing functionality in accordance with some embodiments of the present disclosure. As described in connection with FIG. 5B, the resource access application 522 may either be installed on the client device 202, or may be executed by the client interface service 514 (or elsewhere in the multi-resource access system 500) and accessed using a web browser (not shown in FIG. 5B) on the client device 202. In some implementations, the client device 202, or a computing system that operates in conjunction with the client device 202 (e.g., a Web server that operates in conjunction with a browser on the client device 202), may, for example, include one or more processors and one or more computer-readable media encoded with instructions which, when executed by the one or more processors, cause the application associated with the client device 202 to perform one or more of the routines 600, 700, 800.

As described in more detail below, the routine 600 (shown in FIG. 6) may correspond to an implementation in which the notification type preference settings 112 are used by an application associated with the client device 202 (e.g., the resource access application 522 shown in FIG. 5C) to determine how to sort, filter, and/or group notifications 546 that have been received from the computing system 106. The routine 700 (shown in FIG. 7) may correspond to an implementation in which the notification type preference settings 112 are additionally or alternatively used to determine weighting values that are to be applied to relevance scores that were assigned to respective notifications 546 by the computing system 106 (e.g., by the analytics service 536 described below in connection with FIG. 5C) to determine weighted relevance scores for the received notifications 546. The routine 800 (shown in FIG. 8) may correspond to an implementation in which the notification type preference settings 112 are additionally or alternatively sent to the computing system 106, so as to allow one or more components of the computing system 106 (e.g., the analytics service 536 described in connection with FIG. 5C) to take such preference settings 112 into account when generating at least some preference-based relevance scores for the notifications 546 that are to be sent to the application associated with the client device 202.

Referring to FIG. 6, the routine 600 may begin when, at a decision step 602, a determination is made that the application associated with the client device 202 (e.g., the resource access application 522) has been accessed by the user 524. In some implementations, for example, the decision step 602 may involve determining whether the user 524 has successfully authenticated to the multi-resource access system 500 using the resource access application 522.

When, at the decision step 602, it is determined that the application has been accessed by a user, the routine 600 may proceed to a step 604, at which the application may determine one or more notification type preference settings 112 that were previously set by the user 524, at least to the extent that the user 524 had previously specified such settings 112. As noted above, in some implementations, the notification service 538 shown in FIG. 5C (or another component of the resource management services 502) may be configured with an API that can be used to store and retrieve data indicative of the notification type preference settings 112 that are input by a user 524. In such implementations, the stored notification type preference settings 112 for the user 524 may be retrieved via such an API. In some implementations, to the extent that the user 524 has not previously specified notification type preference settings 112 for one or more notification types, the API may return one or more default values for respective settings 112. In some implementations, for example, the ranking values for respective notification types managed by the system may be initially set to “0” (e.g., indicating that the corresponding notification types are to be excluded from the user's activity feed 544). In some implementations, the notification service 538 (or other service that is responsible for managing stored notification type preference settings 112) may also be responsible for identifying the types of notifications for which preference setting functionality is to be enabled. For instance, in some implementations, the notification service 538 (or other responsible service) may determine the systems of record 526 to which the user is subscribed to receive notifications 546, and may maintain stored ranking values (either user-set or default) for respective systems of record 526. Further, in some implementations, for one or more systems of record 526, the responsible service may additionally or alternatively identify multiple different types of notifications relating to the same system of record 526, and may maintain stored ranking values (either user-set or default) for such different notification types.

At a decision step 606 of the routine 600, the application associated with the client device 202 (e.g., the resource access application 522) may determine whether it is to cause the client device to display a customized activity feed 544 based on the notification type preference settings 112 determined at the step 604. In some implementations, the application may determine to present a customized activity feed 544 (such as that shown in FIG. 1A) in response to determining that the user 524 of the resource access application 522 (shown in FIG. 5C) has operated the user interface element 570 to select an “organize your feed” option, or another option having a similar designation. As noted previously, selecting such an option may additionally cause the user interface control 122, e.g., including the group of user interface elements 104a-d, to be presented on the display screen 102, together with the customized activity feed 544.

When, at the decision step 606, the application associated with the client device 202 (e.g., the resource access application 522) determines that a customized activity feed 544 is to be displayed, the routine 600 may proceed to a step 608, at which the application may use the notification type preference settings 112 (either user-set or default) determined at the step 604 to generate the customized activity feed 544 by sorting, filtering, and/or grouping the notifications 546 the application received from the notification service 538 in accordance with those settings 112. Examples of techniques that the application may use to achieve such sorting/filtering/grouping based on the determined notification type preference settings 112 are described in detail above, in Section A.

At a decision step 610 of the routine 600, the application associated with the client device 202 (e.g., the resource access application 522) may determine whether the notification type preference settings 112 have been modified by the user 524. In some implementations, for example, the application may determine that the user 524 has changed the ranking values indicated by one or more of the user input elements 104a-d shown in FIG. 1A. When, at the decision step 610, the application determines that the one or more of the notification type preference settings 112 has been changed, the routine 600 may proceed to a step 612, at which the modified settings 112 may be stored. When, on the other hand, the application determines (at the decision step 610) that the notification type preference setting have not been modified, the application may return to the decision step 606, at which the application may determine whether the client device 202 is to continue displaying the customized activity feed 544 in accordance with the notification type preference settings 112.

In some implementations, at the step 612, in addition to being stored locally (to the application), the application may send the modified settings 112 to the notification service 538 (or other responsible service) for storage, e.g., in connection with a profile of the user 524. In some implementations, for example, an API provided by the notification service 538 (or another service provided within the resource management services 502) may be used to persist modified notification type preference settings 112 to a central storage location. Following the step 612, the routine 600 may return to the decision step 606, at which the application may determine whether the client device 202 is to continue displaying the customized activity feed 544 in accordance with the notification type preference settings 112.

Turning now to FIG. 7, as noted above, the routine 700 may correspond to an implementation in which the notification type preference settings 112 are additionally or alternatively used to determine weighting values that are to be applied to relevance scores that were assigned to respective notifications 546 by the computing system 106 (e.g., by the analytics service 536 described below in connection with FIG. 5C) to determine weighted relevance scores for the received notifications 546.

Steps 702, 704, 706, 712 and 714 of the routine 700 may be essentially the same as the steps 602, 604, 606, 610 and 612, respectively, of the routine 600 described above. The primary difference between the routine 700 and the routine 600 lies in the step 708 and 710. In particular, at the step 708, the application associated with the client device 202 (e.g., the resource access application 522) may use the notification type preference settings 112 (either user-set or default) determined at the step 704 to determine weighted relevance scores for respective notifications 546, and, at the step 710, those weighted relevance scores may be used by the application to sort, filter and/or group the notifications 546 the application receives from the notification service 538. In some implementations, for example, the notification type preference settings 112 may either represent, or be used to calculate (e.g., using a formula) or otherwise determine (e.g., using a look up table), weighting values corresponding to individual settings 112. The application may then apply those weighting values to relevance scores that were assigned to the respective notifications 546 (e.g., by the analytics service 536) to generate the weighted relevance scores that are used for sorting/filtering/grouping at the step 710. In some implementations, for instance, the weighing values may be percentages indicative of the relative preference rankings selected by the user 524, and the relevance scores initially assigned to the notifications 546 may be multiplied by such percentages to calculate the weighted relevance scores. In this way, the notification type preference settings 112 may be used, in combination with the initially assigned relevance scores, to “urge” the user's more preferred notification types toward the beginning of the user's activity feed while still benefiting, at least in part, from the intelligence provided by the trained machine learning models (e.g., within the analytics service 536) used for scoring.

Referring finally to FIG. 8, as noted above, the routine 800 may correspond to an implementation in which the notification type preference settings 112 are additionally or alternatively sent to the computing system 106, so as to allow one or more components of the computing system 106 (e.g., the analytics service 536 described in connection with FIG. 5C) to take such preference settings 112 into account when generating preference-based relevance scores for the notifications 546 that are to be sent to the application associated with the client device 202.

Steps 802, 806 and 808 of the routine 800 may be essentially the same as the steps 606, 610 and 612, respectively, of the routine 600 described above. At the step 804 of the routine 800, however, the application associated with the client device 202 (e.g., the resource access application 522) may receive relevance scores for respective notifications 546 that have been determined based on the notification type preference settings 112 (either default or user-selected) that are stored by the system, e.g., in association with a profile of the user 524. In some implementations, for example, the notification type preference settings 112 may be used as additional features that may be evaluated, together with other relevance-related features, by one or more machine learning models, e.g., within the analytics service 536, to generate relevance scores for the notifications 546 that the notification service 538 sends to the resource access application 522. In some implementations, the analytics service 536 may generate two separate relevance scores for individual notifications, with one score being based on the notification type preference settings 112 stored for the user 524 and another score that is not based on the stored preference settings 112. In such implementations, selection of the “organize your feed” option of the user interface element 570 (e.g., as shown in FIG. 1A) may cause the resource access application 522 to use the preference-based scores to sort the notifications 546 in the activity feed 544, rather than the non-preference based scores. In other implementations, only preference-based scores may be assigned to respective notifications 546, and a different user interface element may be provided that simply allows a user 524 to input preference rankings or the like for particular notification types, without necessarily providing the user with a new view of the activity feed 544 based on modified preference settings 112. The user interface element used for such a purpose may, for example, be titled “Help us improve your feed” or the like.

G. Example Implementations of Methods, Systems, and Computer-Readable Media in Accordance with the Present Disclosure

The following paragraphs (M1) through (M9) describe examples of methods that may be implemented in accordance with the present disclosure.

(M1) A method may be performed that involves receiving, by an application associated with a client device and from a computing system, at least a first notification of a first event of a first system of record accessed by the computing system using first access credentials associated with a user, the first notification being of a first notification type, and a second notification of a second event of a second system of record accessed by the computing system using second access credentials associated with the user, the second notification being of a second notification type; determining data corresponding to at least one input provided by the user to a user interface presented by the client device, the data indicating a first preference for notifications of the first notification type as compared to notifications of the second notification type; and causing, based at least in part on the first preference indicated by the data, the client device to present the first notification earlier than the second notification in an activity feed generated by the application.

(M2) A method may be performed as described in paragraph (M1), wherein the first notification type may correspond to notifications of events of the first system of record; and the second notification type may correspond to notifications of events of the second system of record.

(M3) A method may be performed as described in paragraph (M1) or paragraph (M2), wherein the data may indicate the first preference as a first ranking value for notifications of the first notification type and a second ranking value for notifications of the second notification type, and causing the client device to present the first notification earlier in the activity feed than the second notification may comprises generating, by the application and based at least in part on the first ranking value and the second ranking value, the activity feed such that notifications of the first notification type appear earlier in the activity feed than notifications of the second notification type.

(M4) A method may be performed as described in paragraph (M3), and may further involve generating, by the application, the user interface to allow a user to select the first ranking value for notifications of the first notification type and the second ranking value for notifications of the second notification type.

(M5) A method may be performed as described in any of paragraphs (M1) through (M4), and may further involve sending the data to the computing system; receiving, by the application and from the computing system, first and second relevance scores for the first and the second notifications, respectively, the first and second relevance scores having been determined by the computing system based at least in part on the data; and determining, by the application, a relative order of the first and second notifications in the activity feed based at least in part on the first and second relevance scores.

(M6) A method may be performed as described in any of paragraphs (M1) through (M5), and may further involve receiving, by the application, a third notification of a third event of a third system of record accessed by the computing system using third access credentials associated with the user, the third notification being of a third notification type; determining that the data further indicates a second preference to exclude notifications of the third notification type from the activity feed; and further causing, based at least in part on the second preference indicated by the data, the client device to refrain from including the third notification in the activity feed.

(M7) A method may be performed as described in paragraph (M6), wherein the third notification type corresponds to notifications of events of the third system of record.

(M8) A method may be performed as described in any of paragraphs (M1) through (M7), and may further involve generating, by the application, the user interface to allow a user to select a first ranking value for notifications of the first notification type and a second ranking value for notifications of the second notification type; and determining a relative order in which the client device is to present the first and second notifications in the activity feed based at least in part on the first ranking value and the second ranking value.

(M9) A method may be performed as described in any of paragraphs (M1) through (M8), and may further involve receiving, by the application and from the computing system, a first relevance score for the first notification; receiving, by the application and from the computing system, a second relevance score for the second notification; and determining, based at least in part on the data, a first weighting value for notifications of the first notification type and a second weighting value for notifications of the second notification type; wherein causing the client device to present the first notification earlier in the activity feed than the second notification comprises combining, by the application, the first weighting value with the first relevance score to obtain a first weighted relevance score, combining, by the application, the second weighting value with the second relevance score to obtain a second weighted relevance score, and determining, by the application, a relative order of the first and second notifications in the activity feed based at least in part on the first and second weighted relevance scores.

The following paragraphs (S1) through (S9) describe examples of systems and devices that may be implemented in accordance with the present disclosure.

(51) A first computing system may comprise at least one processor and at least one computer-readable medium encoded with instructions which, when executed by the at least one processor, cause the first computing system to receive, by an application associated with a client device and from a second computing system, at least a first notification of a first event of a first system of record accessed by the second computing system using first access credentials associated with a user, the first notification being of a first notification type, and a second notification of a second event of a second system of record accessed by the second computing system using second access credentials associated with the user, the second notification being of a second notification type, to determine data corresponding to at least one input provided by the user to a user interface presented by the client device, the data indicating a first preference for notifications of the first notification type as compared to notifications of the second notification type, and to cause, based at least in part on the first preference indicated by the data, the client device to present the first notification earlier than the second notification in an activity feed generated by the application.

(S2) A first computing system may be configured as described in paragraph (S1), wherein the first notification type may correspond to notifications of events of the first system of record; and the second notification type may correspond to notifications of events of the second system of record.

(S3) A first computing system may be configured as described in paragraph (S1) or paragraph (S2), wherein the data may indicate the first preference as a first ranking value for notifications of the first notification type and a second ranking value for notifications of the second notification type, and the at least one computer-readable medium may be further encoded with additional instructions which, when executed by the at least one processor, further cause the first computing system to cause the client device to present the first notification earlier in the activity feed than the second notification at least in part by generating, by the application and based at least in part on the first ranking value and the second ranking value, the activity feed such that notifications of the first notification type appear earlier in the activity feed than notifications of the second notification type.

(S4) A first computing system may be configured as described in paragraph (S3), wherein the at least one computer-readable medium may be further encoded with additional instructions which, when executed by the at least one processor, further cause the first computing system to generate, by the application, the user interface to allow a user to select the first ranking value for notifications of the first notification type and the second ranking value for notifications of the second notification type.

(S5) A first computing system may be configured as described in any of paragraphs (S1) through (S4), wherein the at least one computer-readable medium may be further encoded with additional instructions which, when executed by the at least one processor, further cause the first computing system to send the data to the second computing system, to receive, by the application and from the second computing system, first and second relevance scores for the first and the second notifications, respectively, the first and second relevance scores having been determined by the second computing system based at least in part on the data, and to determine, by the application, a relative order of the first and second notifications in the activity feed based at least in part on the first and second relevance scores.

(S6) A first computing system may be configured as described in any of paragraphs (S1) through (S5), wherein the at least one computer-readable medium may be further encoded with additional instructions which, when executed by the at least one processor, further cause the first computing system to receive, by the application, a third notification of a third event of a third system of record accessed by the second computing system using third access credentials associated with the user, the third notification being of a third notification type, to determine that the data further indicates a second preference to exclude notifications of the third notification type from the activity feed, and to cause, based at least in part on the second preference indicated by the data, the client device to refrain from including the third notification in the activity feed.

(S7) A first computing system may be configured as described in paragraph (S6), wherein the third notification type may correspond to notifications of events of the third system of record.

(S8) A first computing system may be configured as described in any of paragraphs (S1) through (S7), wherein the at least one computer-readable medium may be further encoded with additional instructions which, when executed by the at least one processor, further cause the first computing system to generate, by the application, the user interface to allow a user to select a first ranking value for notifications of the first notification type and a second ranking value for notifications of the second notification type, and to determine a relative order in which the client device is to present the first and second notifications in the activity feed based at least in part on the first ranking value and the second ranking value.

(S9) A first computing system may be configured as described in any of paragraphs (S1) through (S8), wherein the at least one computer-readable medium may be further encoded with additional instructions which, when executed by the at least one processor, further cause the first computing system to receive, by the application and from the second computing system, a first relevance score for the first notification, to receive, by the application and from the second computing system, a second relevance score for the second notification, to determine, based at least in part on the data, a first weighting value for notifications of the first notification type and a second weighting value for notifications of the second notification type, and to cause the client device to present the first notification earlier in the activity feed than the second notification at least in part by combining, by the application, the first weighting value with the first relevance score to obtain a first weighted relevance score, combining, by the application, the second weighting value with the second relevance score to obtain a second weighted relevance score, and determining, by the application, a relative order of the first and second notifications in the activity feed based at least in part on the first and second weighted relevance scores.

The following paragraphs (CRM1) through (CRM9) describe examples of computer-readable media that may be implemented in accordance with the present disclosure.

(CRM1) At least one non-transitory computer-readable medium may be encoded with instructions which, when executed by at least one processor of a first computing system, may cause the first computing system to receive, by an application associated with a client device and from a second computing system, at least a first notification of a first event of a first system of record accessed by the second computing system using first access credentials associated with a user, the first notification being of a first notification type, and a second notification of a second event of a second system of record accessed by the second computing system using second access credentials associated with the user, the second notification being of a second notification type, to determine data corresponding to at least one input provided by the user to a user interface presented by the client device, the data indicating a first preference for notifications of the first notification type as compared to notifications of the second notification type, and to cause, based at least in part on the first preference indicated by the data, the client device to present the first notification earlier than the second notification in an activity feed generated by the application.

(CRM2) At least one non-transitory computer-readable medium may be configured as described in paragraph (CRM1), wherein the first notification type may correspond to notifications of events of the first system of record; and the second notification type may correspond to notifications of events of the second system of record.

(CRM3) At least one non-transitory computer-readable medium may be configured as described in paragraph (CRM1) or paragraph (CRM2), wherein the data may indicate the first preference as a first ranking value for notifications of the first notification type and a second ranking value for notifications of the second notification type, and the at least one computer-readable medium may be further encoded with additional instructions which, when executed by the at least one processor, further cause the first computing system to cause the client device to present the first notification earlier in the activity feed than the second notification at least in part by generating, by the application and based at least in part on the first ranking value and the second ranking value, the activity feed such that notifications of the first notification type appear earlier in the activity feed than notifications of the second notification type.

(CRM4) At least one non-transitory computer-readable medium may be configured as described in paragraph (CRM3), and may be further encoded with additional instructions which, when executed by the at least one processor, further cause the first computing system to generate, by the application, the user interface to allow a user to select the first ranking value for notifications of the first notification type and the second ranking value for notifications of the second notification type.

(CRM5) At least one non-transitory computer-readable medium may be configured as described in any of paragraphs (CRM1) through (CRM4), and may be further encoded with additional instructions which, when executed by the at least one processor, further cause the first computing system to send the data to the second computing system, to receive, by the application and from the second computing system, first and second relevance scores for the first and the second notifications, respectively, the first and second relevance scores having been determined by the second computing system based at least in part on the data, and to determine, by the application, a relative order of the first and second notifications in the activity feed based at least in part on the first and second relevance scores.

(CRM6) At least one non-transitory computer-readable medium may be configured as described in any of paragraphs (CRM1) through (CRM5), and may be further encoded with additional instructions which, when executed by the at least one processor, further cause the first computing system to receive, by the application, a third notification of a third event of a third system of record accessed by the second computing system using third access credentials associated with the user, the third notification being of a third notification type, to determine that the data further indicates a second preference to exclude notifications of the third notification type from the activity feed, and to cause, based at least in part on the second preference indicated by the data, the client device to refrain from including the third notification in the activity feed.

(CRM7) At least one non-transitory computer-readable medium may be configured as described in paragraph (CRM6), wherein the third notification type may correspond to notifications of events of the third system of record.

(CRM8) At least one non-transitory computer-readable medium may be configured as described in any of paragraphs (CRM1) through (CRM7), and may be further encoded with additional instructions which, when executed by the at least one processor, further cause the first computing system to generate, by the application, the user interface to allow a user to select a first ranking value for notifications of the first notification type and a second ranking value for notifications of the second notification type, and to determine a relative order in which the client device is to present the first and second notifications in the activity feed based at least in part on the first ranking value and the second ranking value.

(CRM9) At least one non-transitory computer-readable medium may be configured as described in any of paragraphs (CRM1) through (CRM8), and may be further encoded with additional instructions which, when executed by the at least one processor, further cause the first computing system to receive, by the application and from the second computing system, a first relevance score for the first notification, to receive, by the application and from the second computing system, a second relevance score for the second notification, to determine, based at least in part on the data, a first weighting value for notifications of the first notification type and a second weighting value for notifications of the second notification type, and to cause the client device to present the first notification earlier in the activity feed than the second notification at least in part by combining, by the application, the first weighting value with the first relevance score to obtain a first weighted relevance score, combining, by the application, the second weighting value with the second relevance score to obtain a second weighted relevance score, and determining, by the application, a relative order of the first and second notifications in the activity feed based at least in part on the first and second weighted relevance scores.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
receiving, by an application associated with a client device and from a computing system, at least:
a first notification of a first event of a first system of record accessed by the computing system using first access credentials associated with a user, the first notification being of a first notification type, and
a second notification of a second event of a second system of record accessed by the computing system using second access credentials associated with the user, the second notification being of a second notification type;
determining first data corresponding to a first input provided by the user to a user interface presented by the client device and second data corresponding to a second input provided by the user to the user interface, the first data indicating a first ranking value for notifications of the first notification type and the second data indicating a second ranking value for notifications of the second notification type, wherein relative values of the first ranking value and the second ranking value indicate a first preference for notifications of the first notification type as compared to notifications of the second notification type; and
causing, based at least in part on the first preference indicated by the relative values of the first ranking value and the second ranking value, the client device to present the first notification earlier than the second notification in an activity feed generated by the application, the activity feed including both the first notification and the second notification.

2. The method of claim 1, wherein:
the first notification type corresponds to notifications of events of the first system of record; and
the second notification type corresponds to notifications of events of the second system of record.

3. (canceled)

4. The method of claim 1, further comprising:
generating, by the application, the user interface to allow a user to select the first ranking value for notifications of the first notification type and the second ranking value for notifications of the second notification type.

5. The method of claim 4, wherein:
the first notification type corresponds to notifications of events of the first system of record; and
the second notification type corresponds to notifications of events of the second system of record.

6. The method of claim 1, further comprising:
sending the first data and the second data to the computing system;
receiving, by the application and from the computing system, a first relevance score and a second relevance score for the first notification and the second notification, respectively, the first relevance score having been determined by the computing system based at least in part on the first data and the second relevance score having been determined by the computing system based at least in part on the second data; and
determining, by the application, a relative order of the first notification and the second notification in the activity feed based at least in part on the first relevance score and the second relevance score.

7. The method of claim 1, further comprising:
receiving, by the application, a third notification of a third event of a third system of record accessed by the computing system using third access credentials associated with the user, the third notification being of a third notification type;
determining third data corresponding to a third input provided by the user to the user interface, the third data indicating a second preference to exclude notifications of the third notification type from the activity feed; and
further causing, based at least in part on the second preference indicated by the third data, the client device to refrain from including the third notification in the activity feed.

8. The method of claim 7, wherein:
the first notification type corresponds to notifications of events of the first system of record;
the second notification type corresponds to notifications of events of the second system of record; and
the third notification type corresponds to notifications of events of the third system of record.

9. (canceled)

10. The method of claim 1, further comprising:
receiving, by the application and from the computing system, a first relevance score for the first notification;
receiving, by the application and from the computing system, a second relevance score for the second notification;
determining, based at least in part on the first data, a first weighting value for notifications of the first notification type; and
determining, based at least in part on the second data, a second weighting value for notifications of the second notification type;
wherein causing the client device to present the first notification earlier in the activity feed than the second notification comprises:
combining, by the application, the first weighting value with the first relevance score to obtain a first weighted relevance score,
combining, by the application, the second weighting value with the second relevance score to obtain a second weighted relevance score, and
determining, by the application, a relative order of the first notification and the second notification in the activity feed based at least in part on the first weighted relevance score and the second weighted relevance score.

11. A first computing system, comprising:
at least one processor; and
at least one computer-readable medium encoded with instructions which, when executed by the at least one processor, cause the first computing system to:
receive, by an application associated with a client device and from a second computing system, at least:
a first notification of a first event of a first system of record accessed by the second computing system using first access credentials associated with a user, the first notification being of a first notification type, and
a second notification of a second event of a second system of record accessed by the second computing system using second access credentials associated with the user, the second notification being of a second notification type,
determine first data corresponding to a first input provided by the user to a user interface presented by the client device and second data corresponding to a second input provided by the user to the user interface, the first data indicating a first ranking value for notifications of the first notification type and the second data indicating a second ranking value for notifications of the second notification type, wherein relative values of the first ranking value and the second ranking value indicate a first preference for notifications of the first notification type as compared to notifications of the second notification type, and
cause, based at least in part on the first preference indicated by the relative values of the first ranking value and the second ranking value, the client device to present the first notification earlier than the second notification in an activity feed generated by the application, the activity feed including both the first notification and the second notification.

12. The first computing system of claim 11, wherein:
the first notification type corresponds to notifications of events of the first system of record; and
the second notification type corresponds to notifications of events of the second system of record.

13. (canceled)

14. The first computing system of claim 11, wherein the at least one computer-readable medium is further encoded with additional instructions which, when executed by the at least one processor, further cause the first computing system to:
generate, by the application, the user interface to allow a user to select the first ranking value for notifications of the first notification type and the second ranking value for notifications of the second notification type.

15. The first computing system of claim 11, wherein the at least one computer-readable medium is further encoded with additional instructions which, when executed by the at least one processor, further cause the first computing system to:
send the first data and the second data to the second computing system;
receive, by the application and from the second computing system, a first relevance score and a second relevance score for the first notification and the second notification, respectively, the first relevance score having been determined by the second computing system based at least in part on the first data and the second relevance score having been determined by the second computing system based at least in part on the second data; and
determine, by the application, a relative order of the first notification and the second notification in the activity feed based at least in part on the first relevance score and the second relevance score.

16. The first computing system of claim 11, wherein the at least one computer-readable medium is further encoded with additional instructions which, when executed by the at least one processor, further cause the first computing system to:
receive, by the application, a third notification of a third event of a third system of record accessed by the second computing system using third access credentials associated with the user, the third notification being of a third notification type;
determine third data corresponding to a third input provided by the user to the user interface, the third data indicating a second preference to exclude notifications of the third notification type from the activity feed; and
further cause, based at least in part on the second preference indicated by the third data, the client device to refrain from including the third notification in the activity feed.

17. The first computing system of claim 16, wherein:
the first notification type corresponds to notifications of events of the first system of record;
the second notification type corresponds to notifications of events of the second system of record; and
the third notification type corresponds to notifications of events of the third system of record.

18. (canceled)

19. The first computing system of claim 11, wherein the at least one computer-readable medium is further encoded with additional instructions which, when executed by the at least one processor, further cause the first computing system to:
receive, by the application and from the second computing system, a first relevance score for the first notification;
receive, by the application and from the second computing system, a second relevance score for the second notification;
determine, based at least in part on the first data, a first weighting value for notifications of the first notification type;
determine, based at least in part on the second data, a second weighting value for notifications of the second notification type; and
cause the client device to present the first notification earlier in the activity feed than the second notification at least in part by:
combining, by the application, the first weighting value with the first relevance score to obtain a first weighted relevance score,
combining, by the application, the second weighting value with the second relevance score to obtain a second weighted relevance score, and
determining, by the application, a relative order of the first notification and the second notification in the activity feed based at least in part on the first weighted relevance score and the second weighted relevance score.

20. At least one non-transitory computer-readable medium encoded with instructions which, when executed by at least one processor of a first computing system, cause the first computing system to:
receive, by an application associated with a client device and from a second computing system, at least:
a first notification of a first event of a first system of record accessed by the second computing system using first access credentials associated with a user, the first notification being of a first notification type, and
a second notification of a second event of a second system of record accessed by the second computing system using second access credentials associated with the user, the second notification being of a second notification type;
determine first data corresponding to a first input provided by the user to a user interface presented by the client device and second data corresponding to a second input provided by the user to the user interface, the first data indicating a first ranking value for notifications of the first notification type and the second data indicating a second ranking value for notifications of the second notification type, wherein relative values of the first ranking value and the second ranking value indicate a first preference for notifications of the first notification type as compared to notifications of the second notification type; and
cause, based at least in part on the first preference indicated by the relative values of the first ranking value and the second ranking value, the client device to present the first notification earlier than the second notification in an activity feed generated by the application, the activity feed including both the first notification and the second notification.

21. The at least one non-transitory computer-readable medium of claim 20, further encoded with additional instructions which, when executed by the at least one processor, further cause the first computing system to:
generate the user interface to allow a user to select the first ranking value for notifications of the first notification type and the second ranking value for notifications of the second notification type.

22. The at least one non-transitory computer-readable medium of claim 20, wherein:
the first notification type corresponds to notifications of events of the first system of record; and
the second notification type corresponds to notifications of events of the second system of record.

23. The method of claim 1, wherein the first system of record and the second system of record are both remote from the computing system.

24. The first computing system of claim 11, wherein the first system of record and the second system of record are both remote from the first computing system.
